(19) United States
(12) Patent Application Publication
(10) Pub. No.: US 2006/0292973 A1
(43) Pub. Date: Dec. 28, 2006

(54) Smoking enclosure and methods of use

(76) Inventor: Randolph F. Brooks, Beverly Hills, CA (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 11/165,723

(22) Filed: Jun. 24, 2005

(51) Int. Cl. B05B 15/12; B08B 15/02

(52) U.S. Cl. 454/50; 454/56

(57) ABSTRACT

Computer-controlled smoking enclosures that allows users to smoke inside without exposing individuals outside the enclosure to smoke and/or odor. Facilities for e-mail and Internet access, television programming, interactive multimedia programming, presentation of marketing messages, telephone service, and other services are provided within the smoking enclosures, as well as methods of using the same for targeted marketing and other commercial purposes.

### FIELD OF THE INVENTION

The invention relates generally to smoking enclosures and methods of using smoking enclosures for targeted marketing and other commercial purposes.

### BACKGROUND OF THE INVENTION

Regulation of smoking has progressively diminished the number of sites available for smoking and relegated them to inconvenient locations. Secondhand smoke is a mixture of the smoke given off by the burning end of a cigarette, pipe, or cigar, and the smoke exhaled from the lungs of smokers. This mixture contains more than 4,000 substances, more than 40 of which are known to cause cancer in humans or animals and many of which are strong irritants. Eexposure to secondhand smoke is called involuntary smoking or passive smoking. To avoid exposure of nonsmokers to secondhand smoke, smoking is prohibited in most indoor public spaces, and regulation of smoking in outdoor public spaces is increasing.

Among the results of the such regulation is that smokers are more acutely aware than ever of where they are allowed to smoke, and the population of smokers is more and more dense in sites where smoking is allowed. The segregation and isolation of smokers can be exploited commercially through, for example, providing attractive locations for smoking for a fee and therein offering goods, services, and marketing messages tailored specifically for smokers (“targeted marketing”).

Prior smoking booths have addressed some of the problems associated with providing a smoking environment within a nonsmoking area but fail to offer modern entertainment and information services, such as, for example, access to the Internet and e-mail. Additionally, prior smoking booths were generally lacking in contemporary electronic controls.

Accordingly, there is a need for improved smoking enclosures to address the aforementioned and other shortcomings in the prior art. It would be advantageous to provide a smoking enclosure that can be situated in close proximity to nonsmoking areas and that provides smokers with amenities such as entertainment, communications, shopping, business services, and other suitable goods and services. It would also be advantageous to present targeted marketing messages to smokers while they are inside such a smoking enclosure. It would also be advantageous to incorporate computerized controls for managing the various elements of the system. Smoking enclosures suitable for placement in airports and other public spaces where freedom of movement is limited would be particularly advantageous.

### BRIEF SUMMARY

A computer-controlled, substantially airtight smoking enclosure is provided that allows users to smoke inside without exposing individuals outside the enclosure to smoke and/or odor. Facilities for e-mail and Internet access, television programming, interactive multimedia programming, presentation of marketing messages, telephone service, and other services are provided within the smoking enclosure.

### BRIEF DESCRIPTION OF THE DRAWING

FIG. 1 depicts an exemplary smoking enclosure 100.

### DETAILED DESCRIPTION OF THE INVENTION

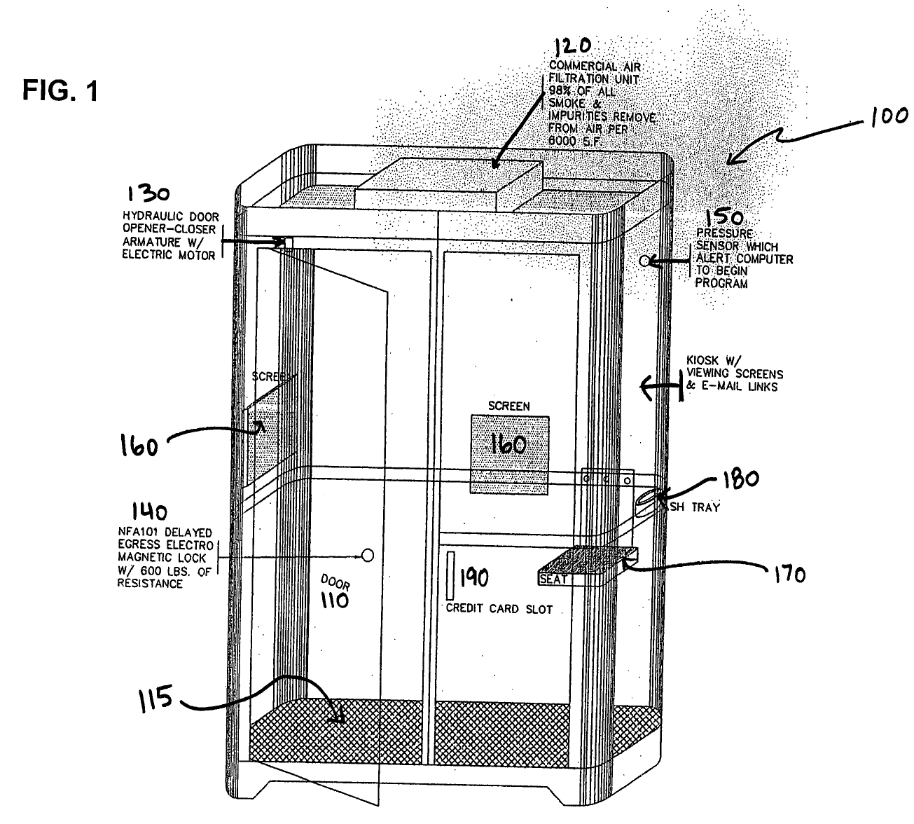

As shown in FIG. 1, a computer-controlled, electronically-operated, self-contained, substantially airtight enclosure 100 is provided that allows users to smoke inside without exposing individuals outside the enclosure to secondhand smoke and/or associated odor. At least one computer processor 105 (not shown in FIG. 1) is provided for monitoring and controlling the functions of some or all of the elements of the smoking enclosure. Exemplary processors are available from Ambient Control Systems, Inc. (El Cajon, Calif.). Preferred embodiments include facilities for e-mail and Internet access, television programming, interactive multimedia programming, presentation of marketing messages, telephone service, and other services.

A payment acceptor 190 may be provided for accepting payment of access fees by cash, charge card (e.g., credit cards and debit cards), or any other suitable method of payment. Alternatively, a user may purchase credits (e.g., a prepaid card or gift card) or a membership (i.e., a right to enter during a specified period of time) to gain access. Access may be provided at a flat rate, a per-minute rate, a combination of the two, or any other fee structure. Any suitable charge card processing system may be used, such as, for example, the Hughes Network Systems VSAT system available from Hughes Network Systems (Germantown, Md.).

An access control device 140, such as, for example, an electronically controlled electromagnetic lock, is provided to control access, including, but not limited to, by only providing access to paying users. At least one pressure sensor 150 or other appropriate sensor may be provided to detect the presence of a user and trigger the operation of the various elements of the smoking enclosure. Exemplary sensors are available from Magnetic Sensor Systems, Inc. (Van Nuys, Calif.).

Surveillance equipment 115 (not shown in FIG. 1), such as, for example, cameras and/or microphones, may be provided for monitoring of the smoking enclosure for security and maintenance issues.

Video outputs 160 and audio outputs 165 (not shown in FIG. 1) are provided for presenting marketing messages, television, multimedia entertainment, access to e-mail and the Internet, and like functions. Flat panel displays, such as, for example, plasma and LCD display panels, are currently preferred video outputs due to their space-saving form factor. Also currently preferred are display panels with touch screen capability for receiving user input. Exemplary touch screens are available from CyberTouch (Newbury Park, Calif.). A ticker display 155 (not shown in FIG. 1) of the type commonly referred to as a “stock ticker” may also be provided to scroll text, such as stock prices and news headlines, horizontally on a display. In some embodiments, hardware and software may be provided for business productivity applications such as the Microsoft Office® suite or any other applications, such as games, that may be desired by users. User input devices may be provided, such as, for example, touch screens, keyboards, mice, speech recognition devices, or other suitable input devices.

The smoking enclosure may be constructed of any appropriate building material and in any configuration appropriate for a given application. The smoking enclosure is airtight or substantially airtight to prevent smoke and/or odor from escaping. A sealable entry 110 is provided to allow users to gain access to the interior of the enclosure while substantially preventing smoke and/or odor from escaping when the sealable entry is closed. An automatic door mechanism 130 may be provided to open and close the sealable entry, such as, for example, the door opener systems available from Monarch Hydraulics, Inc. (Grand Rapids, Mich.). A slip-resistant surface 115 may be provided on the floor of the smoking enclosure. The specific design of the enclosure and the selection of appropriate materials and construction of the same are within ordinary skill.

A ventilation system 120 is provided, preferably, but not necessarily, including air filtration capabilities. The ventilation system 120 includes at least a fresh air intake and an exhaust vent. Preferably, the ventilation system 120 provides for smoky air produced inside the enclosure to be expelled away from non-smoking areas and/or cleaned and recycled. Suitable air filtration systems are available from, for example, Airsopure, Inc. (Dallas, Tex.) and Pure n Natural Systems, Inc. (Morton Grove, Ill.). Heating and air conditioning systems may also be included. In some embodiments, the enclosure is constructed of material that is both transparent and airtight, such as, glass, Plexiglas®, or the like. Where privacy inside the enclosure is desired, the enclosure may be constructed of an opaque material or a material such as one-way glass that allows users to see out of the enclosure by does not allow the interior to be viewed from outside. In some embodiments, an upper part of the enclosure is opaque to provide privacy and the lower part of the enclosure is transparent so that, for example, items left inside the enclosure can be easily seen and retrieved. Any combination of transparent material, opaque material, and/or one-way glass-like material may be used.

In yet other embodiments, the enclosure is of sufficient size to accommodate a plurality of users and may include furniture, such as, for example, seat 170 and other accoutrements to enhance users' comfort and enjoyment, such as, for example, vending of smoking material and accessories, a beverage bar, a concierge/hospitality station, or any other amenity intended to attract and retain users.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A smoking enclosure, comprising:
a substantially airtight structure with a sealable entry, wherein the substantially airtight structure is configured to prevent escape therefrom of secondhand smoke;
a computer processor;
a ventilation system under control of the computer processor;
an access control device under control of the computer processor;
at least one video output or audio output under control of the computer processor; and
a payment acceptor in communication with the computer processor.

2. The smoking enclosure of claim 1, further comprising computer hardware and software for Internet browsing; and a network connection.

3. The smoking enclosure of claim 1, further comprising computer hardware and software for e-mail access; and a network connection.

4. The smoking enclosure of claim 1, further comprising computer hardware and software for business productivity applications.

5. The smoking enclosure of claim 1, further comprising computer hardware and software for computer games.

6. The smoking enclosure of claim 1, wherein the ventilation system comprises an air cleaning system.

7. The smoking enclosure of claim 1, wherein the access control system comprises a lock.

8. The smoking enclosure of claim 1, wherein the access control system comprises an electromagnetic lock.

9. The smoking enclosure of claim 1, wherein the at least one video output or audio output comprises a flat screen display.

10. The smoking enclosure of claim 1, wherein the at least one video output or audio output comprises a touch screen display.

11. The smoking enclosure of claim 1, wherein the at least one video output or audio output comprises a plurality of video displays.

12. The smoking enclosure of claim 1, wherein the at least one video output or audio output comprises a ticker display.

13. The smoking enclosure of claim 1, wherein the payment acceptor comprises a charge card terminal.

14. The smoking enclosure of claim 13, wherein the charge card terminal comprises a wireless network connection.

15. The smoking enclosure of claim 13, wherein the charge card terminal comprises a satellite network connection.

16. The smoking enclosure of claim 1, further comprising at least one seat.

17. The smoking enclosure of claim 1, further comprising a ticker display

18. The smoking enclosure of claim 1, wherein the substantially airtight structure is configured to accommodate a plurality of users.

19. A method of advertising, comprising:
attracting an audience by providing a smoking enclosure, wherein the smoking enclosure comprises:
a substantially airtight structure with a sealable entry, wherein the substantially airtight structure is configured to prevent escape therefrom of secondhand smoke;
a computer processor;
a ventilation system under control of the computer processor;
an access control device under control of the computer processor;
at least one video output or audio output under control of the computer processor; and
a payment acceptor in communication with the computer processor; and
communicating advertisements to the audience via the at least one video output or audio output.
